(19) United States
(12) Patent Application Publication
(10) Pub. No.: US 2007/0280556 A1
(43) Pub. Date: Dec. 6, 2007

(54) System and method for geometry driven registration

(75) Inventors: Rakesh Mullick, Bangalore (IN); Girishankar Gopalakrishnan, Bangalore (IN); Manasi Datar, Mumbai (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/445,767

(22) Filed: Jun. 2, 2006

(51) Int. Cl. G06K 9/32; G06K 9/36

(52) U.S. Cl. 382/294; 382/284

(57) ABSTRACT

A method for imaging is presented. The method includes receiving a first image data set and at least one other image data set. Further the method includes adaptively selecting corresponding regions of interest in each of the first image data set and the at least one other image data set based upon apriori information associated with each of the first image data set and the at least one other image data set. Additionally, the method includes selecting a customized registration method based upon the selected regions of interest and the apriori information corresponding to the selected regions of interest. The method also includes registering each of the corresponding selected regions of interest from the first image data set and the at least one other image data set employing the selected registration method.

### BACKGROUND

The invention relates generally to imaging of an object, and more specifically to registration of two or more images based on geometric and kinematic information of the object in an image.

Image registration finds wide application in medical imaging, video motion analysis, remote sensing, security and surveillance applications. Further, the process of finding the correspondence between the contents of the images is generally referred to as image registration. In other words, image registration includes finding a geometric transform that non-ambiguously links locations and orientations of the same objects or parts thereof in the different images. More particularly, image registration includes transforming the different sets of image data to a common coordinate space. The images may be obtained by different imaging devices or alternatively by the same imaging device but at different imaging sessions or time frames. As will be appreciated, in the field of medical imaging, there has been a steady increase in the number of imaging sessions or scans a patient undergoes. Images of a body part may be obtained either temporally from the same imaging modality or system. Alternatively, in multi-modal imaging, images of the same body parts may be captured via use of different imaging modalities such as an X-ray imaging system, a magnetic resonance (MR) imaging system, a computed tomography (CT) imaging system, an ultrasound imaging system or a positron emission tomography (PET) imaging system.

In medical registration, registration of images is confronted by the challenges associated with patient movement. For example, due to either conscious or unconscious movement of the patient between two scans obtained either via the same imaging modality or otherwise, there exists an unpredictable change between the two scans. Further, it has been commonly observed that there is discernable change in the position of the head of the patient between scans. Unfortunately, this change in position leads to misalignment of the images. More particularly, the degree of misalignment above and below the neck joint is different thereby preventing use of a common transform to recover the misalignment in the entire image volume. Additionally, patient position may vary depending on the imaging modalities used for multi-modal scanning. For example, a patient is generally positioned in the prone position (i.e. lying face down) for a magnetic resonance imaging (MRI) scanning session and may be in the supine position (i.e. lying face up) during a colon exam scanning session thereby creating inherent registration problems.

Previously conceived solutions include use of hierarchical methods, piece-wise registration methods, non-rigid registration methods and finite element based approaches. While use of sub-division based registration methods is widespread, methods to segment images based on points that allow known degrees of freedom followed by independent registration and combining have not been attempted. Also, currently available algorithms have performed piece-wise registrations where the regions of interest within a volume are selected based on structure or intensity. However, these piece-wise algorithms tend to be very slow and are unable to recover large deformations. Additionally, finite element based registration techniques have been recommended in the literature but have not been implemented or proven to work. Finite element based techniques for image registration suffer from drawbacks such as wasteful computation and inaccuracies.

There is therefore a need for a design of a method and system capable of efficiently registering images obtained via a single modality or a plurality of imaging modalities. In particular, there is a significant need for a design of a method and a system for adaptively registering images based upon selected regions of interest in the object under consideration. Also, it would be desirable to develop a method of registering images that enhances computational efficiency while minimizing errors.

### BRIEF DESCRIPTION

Briefly, in accordance with aspects of the technique, a method for imaging is presented. The method includes receiving a first image data set and at least one other image data set. Further the method includes adaptively selecting corresponding regions of interest in each of the first image data set and the at least one other image data set based upon apriori information associated with each of the first image data set and the at least one other image data set. Additionally, the method includes selecting a customized registration method based upon the selected regions of interest and the apriori information corresponding to the selected regions of interest. The method also includes registering each of the corresponding selected regions of interest from the first image data set and the at least one other image data set employing the selected registration method. Computer-readable medium and systems that afford functionality of the type defined by this method are also contemplated in conjunction with the present technique.

In accordance with further aspects of the technique, a method for imaging is presented. The method includes receiving a first image data set and at least one other image data set. In addition, the method includes adaptively selecting corresponding regions of interest in each of the first image data set and the at least one other image data set based upon apriori information associated with each of the first image data set and the at least one other image data set. Furthermore, the method includes selecting a customized registration method based upon the selected regions of interest and the apriori information corresponding to the selected regions of interest. The method also includes registering each of the corresponding selected regions of interest from the first image data set and the at least one other image data set employing the selected registration method to generate registered sub-images associated with the selected regions of interest. In addition, the method includes combining the registered sub-images to generate a combined registered image.

In accordance with yet another aspect of the technique, a system is presented. The system includes at least one imaging system configured to obtain a first image data set and at least one other image data set. Moreover, the system includes a processing sub-system operationally coupled to the at least one imaging system and configured to process each of the first image data set and the at least one other image data set to generate a registered image based upon selected regions of interest and apriori information corresponding to the selected regions of interest.

### DRAWINGS

These and other features, aspects, and advantages of the invention will become better understood when the following detailed description is read with reference to the accompanying drawings in which like characters represent like parts throughout the drawings, wherein:

FIG. 1 is a block diagram of an exemplary imaging system, in accordance with aspects of the present technique;

FIG. 2 is a flow chart illustrating the operation of the imaging system illustrated in FIG. 1, in accordance with aspects of the present technique;

FIG. 3 is a flow chart illustrating the operation of the processing module illustrated in FIG. 1, in accordance with aspects of the present technique; and

FIG. 4 is a flow chart illustrating the operation of a geometry based registration algorithm, in accordance with aspects of the present technique.

### DETAILED DESCRIPTION

As will be described in detail hereinafter, an imaging system capable of geometry based registration of images, and methods of imaging are presented. Computational efficiency may be enhanced while minimizing errors by employing the systems and methods of geometry based registration of images. Although, the exemplary embodiments illustrated hereinafter are described in the context of a medical imaging system, it will be appreciated that use of the imaging system capable of geometry based registration of images in industrial applications are also contemplated in conjunction with the present technique. The industrial applications may include applications, such as, but not limited to, baggage scanning applications, and other security and surveillance applications.

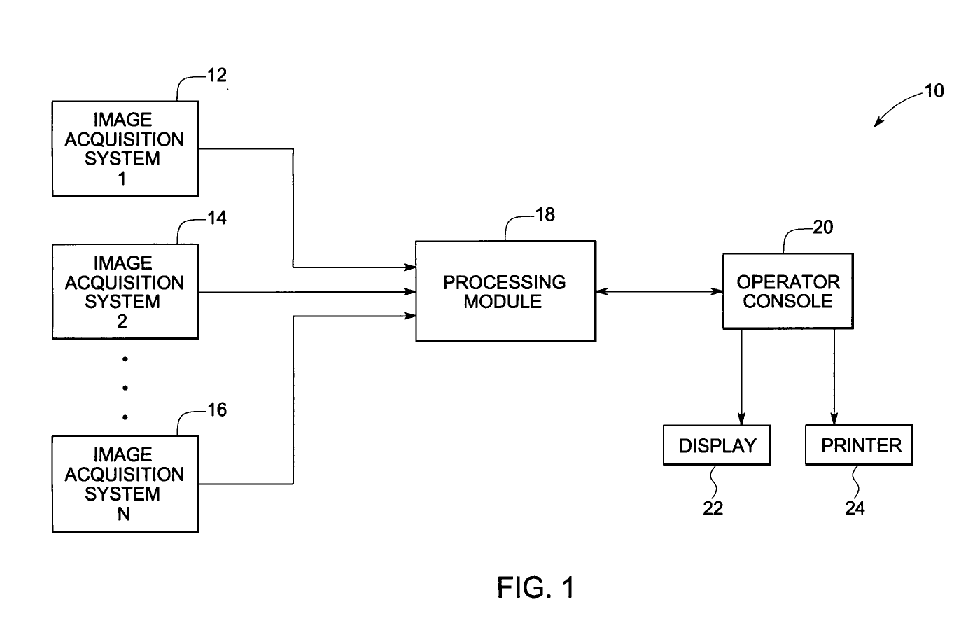

FIG. 1 is a block diagram of an exemplary system 10 for use in imaging, in accordance with aspects of the present technique. As will be appreciated by one skilled in the art, the figures are for illustrative purposes and are not drawn to scale. The system 10 may be configured to facilitate acquisition of image data from a patient (not shown) via a plurality of image acquisition systems. In the illustrated embodiment of FIG. 1, the imaging system 10 is illustrated as including a first image acquisition system 12, a second image acquisition system 14 and an N^{th} image acquisition system 16. It may be noted that the first image acquisition system 12 may be configured to obtain a first image data set representative of the patient under observation. In a similar fashion, the second image acquisition system 14 may be configured to facilitate acquisition of a second image data set associated with the same patient, while the N^{th} image acquisition system 16 may be configured to facilitate acquisition of an N^{th} image data set from the same patient.

In accordance with one aspect of the present technique, the imaging system 10 is representative of a multi-modality imaging system. In other words, a variety of image acquisition systems may be employed to obtain image data representative of the same patient. More particularly, in certain embodiments each of the first image acquisition system 12, the second image acquisition system 14 and the N^{th} image acquisition system 16 may include a CT imaging system, a PET imaging system, an ultrasound imaging system, an X-ray imaging system, an MR imaging system, an optical imaging system or combinations thereof. For example, in one embodiment, the first image acquisition system 12 may include a CT imaging system, while the second image acquisition system 14 may include a PET imaging system and the N^{th} image acquisition system 16 may include an ultrasound imaging system. It may be noted that it is desirable to ensure similar dimensionality of the various image acquisition systems in the multi-modality imaging system 10. In other words, in one embodiment, it is desirable that in the multi-modality imaging system 10, each of the various image acquisition systems 12, 14, 16 includes a two-dimensional image acquisition system. Alternatively, in certain other embodiments, the multi-modality imaging system 10 entails use of three-dimensional image acquisition systems 12, 14, 16. Accordingly, in the multi-modality imaging system 10, a plurality of images of the same patient may be obtained via the various image acquisition systems 12, 14, 16.

Further, in certain other embodiments, the imaging system 10 may include one image acquisition system, such as the first image acquisition system 12. In other words, the imaging system 10 may include a single modality imaging system. For example, the imaging system 10 may include only one image acquisition system 12, such as a CT imaging system. In this embodiment, a plurality of images, such as a plurality of scans taken over a period of time, of the same patient may be obtained by the same image acquisition system 12.

The plurality of image data sets representative of the patient that have been obtained either by a single modality imaging system or by different image acquisition modalities may then be merged to obtain a combined image. As will be appreciated by those skilled in the art, imaging modalities such as PET imaging systems and single photon emission computed tomography (SPECT) imaging systems may be employed to obtain functional body images which provide physiological information, while imaging modalities such as CT imaging systems and MR imaging systems may be used to acquire structural images of the body which provide anatomic maps of the body. These different imaging techniques are known to provide image data sets with complementary and occasionally conflicting information regarding the body. It may be desirable to reliably coalesce these image data sets to facilitate generation of a composite, overlapping image that may include additional clinical information which may not be apparent in each of the individual image data sets. More particularly, the composite image facilitates clinicians to obtain information regarding shape, size and spatial relationship between anatomical structures and any pathology, if present.

Moreover, the plurality of image data sets obtained via a single imaging modality system may also be combined to generate a composite image. This composite image may facilitate clinicians to conduct follow-up studies in the patient or in a comparison of an image with normal uptake properties to an image with suspected abnormalities.

The plurality of acquired image data sets may be “registered” to generate a composite image to facilitate clinicians to compare or integrate data representative of the patient obtained from different measurements. In accordance with aspects of the present technique, image registration techniques may be utilized to coalesce the plurality of image sets obtained by the imaging system 10 via the processing module 18. In the example illustrated in FIG. 1, the processing module 18 is operatively coupled to the image acquisition systems 12, 14, 16. As previously noted, image registration may be defined as a process of transforming the different image data sets into one common coordinate system. More particularly, the process of image registration involves finding one or more suitable transformations that may be employed to transform the image data sets under study to a common coordinate system. In accordance with aspects of the present technique, the transform may include transforms, such as, but not limited to, rigid transforms, non-rigid transforms, or affine transforms. The rigid transforms may include, for example, translations, rotations or combinations thereof. Also, the non-rigid transforms may include finite element modeling (FEM), B-spline transforms, Daemon's (fluid flow based) methods, diffusion based methods, optic flow based methods, or level-set based methods, for example.

As described hereinabove, the processing module 18 may be configured to facilitate the registration of the plurality of acquired image data sets to generate a composite, registered image. It has been observed that the patient under observation typically experiences conscious or unconscious movement while being scanned. Consequently, there is some unpredictable change that may occur either internally or externally between the image data sets acquired either via the same imaging modality or via a multi-modality imaging system. The internal changes may be attributed to motion of organs such as the lungs or the colon. Also, the external changes experienced by the patient are indicative of the involuntary movements of the external body parts of the patient. For example, during a head and torso scan using a CT imaging system and a PET imaging system, or even a subsequent CT scan of the patient, it has been generally observed that the position of the patient's head tends to change. As a result of this movement, there is a misalignment between the images. Additionally, it has also been observed that the degree of misalignment is typically different above and below the neck joint, for example. Consequently, the process of image registration may entail use of more than one transform to efficiently recover the misalignment between the image data sets. There is therefore a need for a customized image registration process that may be tailored according to a region of interest within the image data set. In one embodiment, the processing module 18 may be configured to facilitate implementation of such a customized image registration process.

The processing module 18 may be accessed and/or operated via an operator console 20. The operator console 20 may also be employed to facilitate the display of the composite registered image generated by the processing module 18, such as on a display 22 and/or a printer 24. For example, an operator may use the operator console 20 to designate the manner in which the composite image is visualized on the display 22.

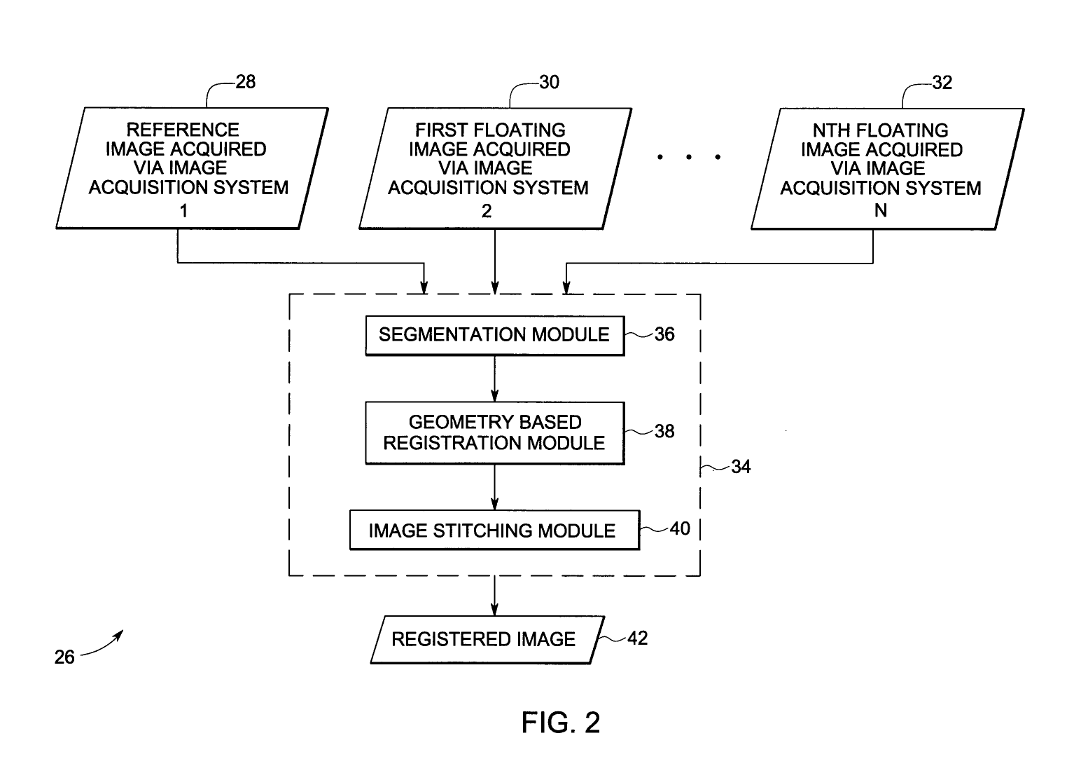

Turning now to FIG. 2, a schematic flow chart 26 representative of the operation of the imaging system 10 of FIG. 1 is depicted. In the example depicted in FIG. 2, reference numerals 28, 30 and 32 are representative of a plurality of image data sets acquired via one or more image acquisition systems, such as image acquisition systems 12, 14, 16 (see FIG. 1). As previously noted, the image data sets 28, 30 and 32 respectively correspond to image data representative of the same patient acquired via different imaging modalities. Alternatively, if a single imaging modality is employed to acquire image data, then the image data sets 28, 30 and 32 embody image data of the same patient acquired via the same kind of imaging modality and taken over a period of time.

Further, the first image data set 28, acquired via the first image acquisition system 12 may be referred to as a “reference” image, where the reference image is the image that is maintained unchanged and thereby used as a reference. It may be noted that the terms reference image, original image, source image and fixed image may be used interchangeably. Additionally, the other acquired images to be mapped onto the reference image may be referred to as “floating” images. In other words, the floating image embodies the image that is geometrically transformed to spatially align with the reference image. It may also be noted that the terms floating image, moving image, sensed image and target image may be used interchangeably. Accordingly, the second image data set acquired via the second image acquisition system 14 may be referred to as a first floating image 30, while the N^{th} image data set acquired via the N^{th} image acquisition system 16 may be referred to as an N^{th} floating image 32.

Following the steps of receiving the plurality of image data sets 28, 30, 32, each of the reference image data set 28, the first floating image data set 30 and the N^{th} floating image data set 32 may be processed by the processing module 18 (see FIG. 1), at step 34. Additionally, in certain embodiments, an optional preprocessing step (not shown) may be applied to the reference image data set 28, the first floating image data set 30 and the N^{th} floating image data set 32 prior to being processed by the processing module 18. For example, an image smoothing and/or an image deblurring algorithm may be applied to the reference image data set 28, the first floating image data set 30 and the N^{th} floating image data set 32 prior to being processed by the processing module 18.

According to exemplary aspects of the present technique, the processing step 34 may involve a plurality of sub-processing steps. In a presently contemplated configuration, each of the reference image data set 28, the first floating image data set 30 and the N^{th} floating image data set 32 may be subject to a selection step (step 36) via a segmentation module, a registration step (step 38) via an geometry driven registration module and a combining step (step 40) via an image stitching module.

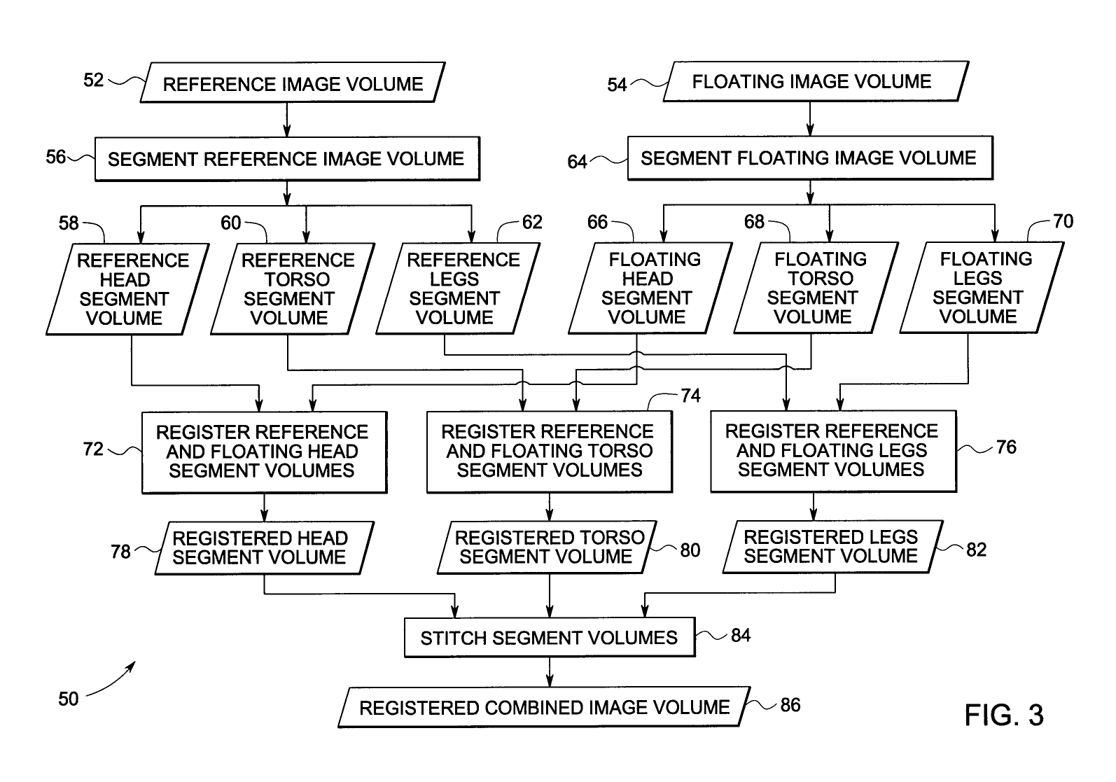

Accordingly, at step 36, a plurality of regions of interest may be adaptively selected in each of the reference image data set 28, the first floating image data set 30 and the N^{th} floating image data set 32. More particularly, each of the reference image data set 28, the first floating image data set 30 and the N^{th} floating image data set 32 may then be segmented into corresponding plurality of regions of interest at step 36. In accordance with aspects of the present technique, the segmentation process may be dependent upon apriori information such as anatomical information and/or kinematic information and will be described in greater detail with reference to FIG. 3.

Subsequently, at step 38 the adaptively segmented regions of interest associated with each of the floating image data sets 30, 32 may be registered with the corresponding region of interest in reference image data set 28 to generate sub-image volumes representative of registered regions of interest. In accordance with exemplary aspects of the present technique, the process of registering regions of interest within the image data sets may be customized based upon the selected region of interest and the apriori information associated with the selected region of interest. Accordingly, the method of registering the corresponding regions of interest may be customized based upon the selected region of interest and the apriori information associated with the selected region of interest. Each of the corresponding regions of interest may then be registered employing the customized method of registration to generate registered sub-volumes representative of the plurality of regions of interest.

Following step 38 where the corresponding regions of interest are registered, the registered sub-image volumes may be combined at step 40 to generate a combined, registered image 42. In one embodiment, the registered image volumes may be combined employing an image stitching technique, such as a volume stitching method. The processing steps described hereinabove will be described in detail with reference to FIG. 3, wherein FIG. 3 illustrates an exemplary embodiment of the method illustrated in FIG. 2.

Referring now to FIG. 3, a flow chart 50, depicting steps for imaging that includes adaptively selecting regions of interest in each of the acquired image data sets based upon apriori information and registering corresponding regions of interest within a plurality of image data sets, in accordance with the present technique, is illustrated. In the example depicted by FIG. 3, a first image data set 52 is acquired via at least one imaging system, as previously noted. Additionally, at least one other image data set 54 may be acquired via the at least one imaging system. It may be noted that in one embodiment, each of the first image data set 52 and the at least one other image data set 54 may be obtained via a plurality of image acquisition systems, as previously described. For example, the first image data set 52 may be acquired via a MR imaging system, while an PET imaging system may be utilized to acquire the at least one other image data set 54. Alternatively, each of the first image data set 52 and the at least one other image data set 54 may be acquired via a single imaging system, such as a CT imaging system. Accordingly, the first image data set 52 and the at least one other image data set 54 acquired via a single imaging system may be representative of scans of the same patient taken at different points in time. Although FIG. 3 depicts a system that uses 2 image data sets, one of ordinary skill in the art will appreciate that the depicted method may be generally applicable to imaging systems employing two or more image data sets.

As previously noted, the first image data set may be referred to as a reference image volume 52. Similarly, the at least one other image data set may be referred to as a floating image volume 54. In addition, an optional preprocessing step (not shown) may be performed on each of the reference image volume 52 and the floating image volume 54 to enhance quality of the acquired image data sets. In certain embodiments, each of the reference image volume 52 and the floating image volume 54 may be preprocessed via application of a noise removal algorithm, an image smoothing and/or an image deblurring algorithm.

Subsequently, each of the reference image volume 52 and the floating image volume 54 may be segmented into a corresponding plurality of anatomical regions of interest. As will be appreciated, segmentation is a process of selecting regions of interest that are a subset of a larger image volume. The patient under observation has been known to experience conscious and/or unconscious movement while being scanned over a prolonged period of time or while being scanned by different imaging modalities. Accordingly, there exists an unpredictable change that occurs both internally and externally. For example, when the patient is being scanned using a CT imaging system and a PET imaging system, the position of the patient's head may change during the acquisition of image data via the two imaging modalities due to possible patient motion. Additionally, different parts of the patient may experience different kinds of motion. For example, the region above the neck is known to experience rigid motion, while the region below the neck is known to undergo non-rigid motion. Consequent to such varying motion, there exists a degree of misalignment between the two images acquired via the different imaging modalities. There is therefore a need for a customized registration process that is configured to facilitate use of an appropriate registration algorithm depending upon the registration requirement of the selected region of interest to.

To address this problem of misalignment of images, the image volumes may be segmented based upon apriori information to facilitate enhanced registration. Accordingly, each of the reference image volume 52 and the floating image volume 54 may be segmented into a plurality of regions of interest based upon the apriori information. In certain embodiments, the apriori information may include anatomical information derived from each of the reference image volume 52 and the floating image volume 54. For example, the anatomical information may include an anatomic landscape indicative of distinct anatomical regions. Alternatively, in certain other embodiments, a digital imaging and communications in medicine (DICOM) header associated with each of the reference image volume 52 and the floating image volume 54 may be employed to obtain pointers associated with regions of interest of the patient to aid in the segmentation process. Each of the reference image volume 52 and the floating image volume 54 may be segmented into respective corresponding regions of interest based upon information from the corresponding digital imaging and communications in medicine (DICOM) header. As will be appreciated DICOM is one of the most common standard utilized to receive scans in a caregiving facility, such as a hospital. The DICOM standard was created to facilitate distribution and visualization of medical images, such as CT scans, MRIs, and ultrasound scans. Typically, a single DICOM file contains a header that stores information regarding the patient, such as, but not limited to, the name of the patient, the type of scan, and image dimensions.

Additionally, in accordance with further aspects of the present technique, the apriori information may also include kinematic information related to the regions of interest. As will be appreciated, kinematics is concerned with the motion of objects without considering the force that causes such a motion. In certain embodiments, the kinematic information may include information regarding degrees of freedom associated with each of the anatomical regions in the anatomic landscape. For example, information regarding movements that result in motion around bone joints may be obtained. More particularly, kinematic information, such as limits of motion along each joint such as the knee, the elbow, the neck, for example, may be acquired and/or computed. It may be noted that the kinematic information may be obtained from external tracking devices.

Subsequently, based upon the relevant apriori information, such as, but not limited to, anatomical information and kinematic information, each of the reference image volume 52 and the floating image volume 54 may be adaptively segmented into a plurality of sub-image volumes associated with a plurality of regions of interest. In other words, an appropriate segmentation algorithm may be applied to segment each of the reference image volume 52 and the floating image volume 54 into a plurality of regions of interest that differ in their registration requirement.

Each of the reference image volume 52 and the floating image volume 54 may be automatically segmented into the plurality of regions of interest based upon the apriori information, as previously described. In one embodiment of the present technique, the anatomy represented in each of the reference image volume 52 and the floating image volume 54 may be automatically segmented into a the plurality of regions such as the neck, the arms, the knees, the pelvis, and other articulated joints. Alternatively, in certain other embodiments, the process of segmenting each of the reference image volume 52 and the floating image volume 54 may be dependent upon user input. More particularly, the user may be able to manually select the regions of interest for segmentation.

As described hereinabove, in certain embodiments, each of the reference image volume 52 and the floating image volume 54 may be segmented into a plurality of regions of interest based upon apriori information, such as anatomical information from the respective DICOM headers and/or kinematic information related to the joints and any knowledge regarding the registration algorithm. Further, as previously noted, the plurality of regions of interest may be representative of different anatomical regions in the patient under observation. Also, in certain embodiments, the reference image volume 52 and the floating image volume 54 may be simultaneously segmented into the corresponding regions of interest. Accordingly, the reference image volume may be segmented into a plurality of regions of interest, at step 56. In the example illustrated in FIG. 3, consequent to the segmentation at step 56, the reference image volume 52 is segmented into three regions of interest, that is, the reference head segment volume 58, the reference torso segment volume 60 and the reference legs segment volume 62. In a similar fashion, the floating image volume 54 may be simultaneously segmented into a plurality of regions of interest at step 64. It may be noted that the floating image volume 54 is segmented into a plurality of regions to match the corresponding regions of interest in the reference image volume 52. In other words, the floating image volume 54 is segmented such that the each of the regions of interest in the floating image volume 54 has a one-to-one correspondence with a corresponding region of interest in the reference image volume 52. Consequently, at step 64, the floating image volume 54 may be segmented into a floating head segment volume 66, a floating torso segment volume 68 and a floating legs segment volume 70.

As previously described, the presence of motion in the reference image volume 52 and the floating image volume 54 may impede the efficient registration of sub-volumes of image data associated with the plurality of regions of interest. Consequent to the adaptive segmentation at steps 56 and 64, each of the segmented regions of interest in the floating image volume 54 may be registered with a corresponding region of interest in the reference image volume 52. Accordingly, in the example illustrated in FIG. 3, the floating head segment volume 66 may be registered with the reference head segment volume 58 at step 72, while the floating torso segment volume 68 may be registered with the reference torso segment volume 60 at step 74. In a similar fashion, at step 76, the floating legs segment volume 70 may be registered with the reference legs segment volume 62.

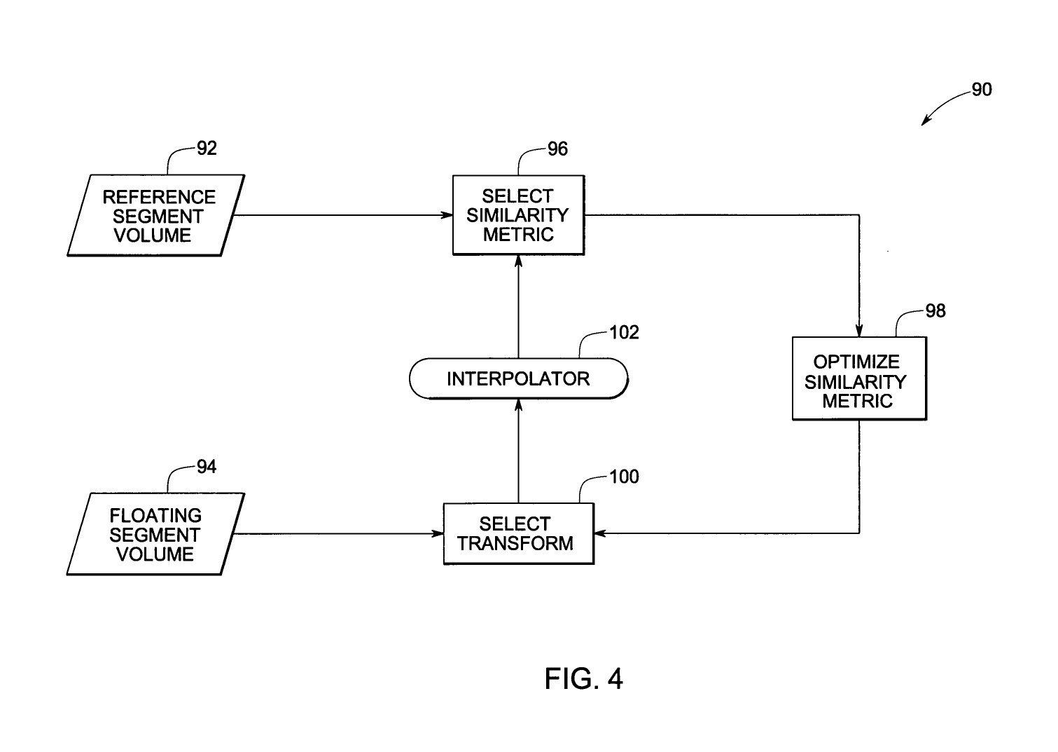

Furthermore, it may be noted that in certain embodiments, prior to the registration steps 72, 74, 76, additional information related to each of the segmented regions of interest may be acquired, where the additional information may also be utilized to adaptively select an appropriate method of registration. The additional information may include type of imaging modality used for image acquisition, elasticity of imaged regions, or nature of the objects under observation, for example. The process of registering the corresponding regions of interest in the reference image volume 52 and the floating image volume 54 (steps 72-76), will be described in greater detail with reference to FIG. 4.

Turning now to FIG. 4, a flow chart 90 depicting the operation of the geometry based registration algorithm employed to register the corresponding sub-volumes of image data associated with the plurality of regions of interest is illustrated. Reference numeral 92 is representative of a reference image sub-volume, while a floating image sub-volume may be represented by reference numeral 94. With reference to the registration step 72 (see FIG. 3), the reference image sub-volume 92 may be indicative of the reference head segment volume 58 (see FIG. 3) and the floating image sub-volume 94 may represent the floating head segment volume 66 (see FIG. 3).

In accordance with exemplary aspects of the present technique, a customized method of registration may be selected depending upon the region of interest under consideration. More particularly, as previously described, the acquired imaging volumes are segmented based upon anatomical information and also kinematic information, in certain embodiments. According to aspects to the present technique, in steps 72, 74 and 76 (see FIG. 3), a method of registration that is most suited to the segmented region of interest is selected. For example, it is known that the head region undergoes rigid motion, where the rigid motion may include rotation, for instance. Accordingly, a rigid transformation may be employed to register images associated with the head region, such as neurological images. However, as will be appreciated, the torso region is known to experience elastic motion. Consequently, a non-rigid transformation may be used to register the images associated with the torso region. The non-rigid transformations may include B-spline based non-rigid registration or finite element modeling, for example.

As will be appreciated, the process of registering the floating segment image volume 94, such as the floating head segment image volume 58, with the reference image segment volume 92, such as the reference head segment volume 66, includes geometrically transforming the floating head segment volume 94 to spatially align with the reference head segment image volume 92. Once a suitable method of registration is selected, the process of registering images may include selection of a similarity metric as indicated by step 96. The similarity metric may include a contrast measure, minimizing means-squared error, correlation ratio, ratio image uniformity (RIU), partitioned intensity uniformity (PIR), mutual information (MI), normalized mutual information (NMI), joint histogram, or joint entropy, for example. In accordance with the process of registration, it may be desirable to optimize a measure associated with the similarity metric as depicted by step 98. The optimization of the measure associated with the similarity metric may involve either maximizing or minimizing the measure associated with the similarity metric. Accordingly, as indicated by step 100, it may be desirable to select a suitable transform such that the measure associated with the similarity metric is optimized. This transform may then be employed to transform the floating head segment volume 94 to the reference head segment volume 92.

In other words, in one embodiment, the coordinates of a set of corresponding points in each of the reference head segment volume 92 and the floating head segment volume 94 may be represented as:

{(xᵢ,yᵢ)(Xᵢ,Yᵢ): i=1,2, . . . ,N} (1)

Given the coordinates as indicated in equation (1), it may be desirable to determine a function ƒ(x,y) with components ƒₓ(x,y) and ƒ_{y}(x,y) such that

Xᵢ=ƒₓ(xᵢ,yᵢ)

and

Yᵢ=ƒ_{y}(xᵢ,yᵢ), where i=1,2, . . . ,N. (2)

The coordinates of corresponding points may then be rearranged as:

{(xᵢ,yᵢ,Xᵢ):i=1,2, . . . ,N}

and

{(xᵢ,yᵢ,Yᵢ): i=1,2, . . . ,N}. (3)

In equation (3), the functions ƒₓ and ƒ_{y} may be representative of two single-valued surfaces fitting to two sets of three-dimensional points. Hence, at step 102, it may be desirable to find the function ƒ(x,y) that approximates:

{(xᵢ,yᵢ,ƒᵢ): i=1,2, . . . ,N} (4)

Steps 96-102 may then be repeated until the floating head segment volume 94 is efficiently registered with the reference head segment volume 92. With returning reference to FIG. 3, consequent to the process carried out by steps 92-102 see FIG. 4), a registered sub-volume 78 representative of the head segment volume is generated. This process of registering (steps 96-102) corresponding sub-volumes may also be applied to register the floating torso segment volume 68 with the reference torso segment volume 60 to generate a registered torso segment sub-volume 80. Similarly, the floating legs segment volume 70 may be registered with the reference legs segment volume 62 to obtain a registered legs segment sub-volume 82. It may be noted that each of the floating segment volumes may be registered with a corresponding reference segment volume employing an appropriate transform that is configured to best align the segment volumes presently under consideration. More particularly, the transform configured to register the floating segment volume with the reference segment volume may be selected based upon anatomical information and/or kinematic information associated with the region of interest that is currently being registered.

As depicted in FIG. 3, consequent to steps 72, 74, 76, a plurality of registered segment sub-volumes is generated. In other words, in the illustrated example of FIG. 3, the registered head segment sub-volume 78, the registered torso segment sub-volume 80 and the registered legs segment sub-volume 82 are obtained. Following steps 72, 74, 76, the plurality of registered segment volumes 78, 80, 82 may be assembled, at step 84, to generate a registered image volume 86, where the registered image volume 86 is representative of registration of the floating image volume 54 with the reference image volume 52.

In accordance with aspects of the present technique, image stitching techniques, such as volume stitching techniques, may be employed to assemble the registered sub-volumes associated with the plurality of regions of interest. Image stitching algorithms take the alignment estimates produced by such registration algorithms and blend the images in a seamless manner, while ensuring that potential problems such as blurring or ghosting caused by movements as well as varying image exposures are accounted for. In one example, the registered head segment volume 78 and the registered legs segment volume 82 may be obtained via the application of a rigid transform, while the registered torso segment volume 80 may be generated via the use of a non-rigid transform. Consequent to the use of different transforms, there may be misalignment between the registered head segment volume 78 and the registered torso segment volume 80. Additionally, the use of different transforms may result in a misalignment between the registered torso segment volume 80 and the registered legs segment volume 82. The image stitching technique may be configured to ensure prevention of blurring, discontinuity, breaks and/or artifacts at adjoining regions, that is at the regions of stitching. To address this problem, in one embodiment, each of the reference image volume 52 and the floating image volume 54 may be segmented such that there exists an overlap of image data between each of the adjacent regions of interest. Subsequent to step 84, the combined, registered image volume 86 may be further processed to facilitate visualization on a display module, such as the display 22 (see FIG. 1) or the printer 24 (see FIG. 1).

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++ or Java. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The various systems and methods for imaging including customized registration of images described hereinabove dramatically enhance computational efficiency of the process of imaging, while minimizing errors. Consequently, speed of the registration process may be greatly improved. As described hereinabove, the adaptive segmentation, custom registration and volume stitching steps are driven by anatomical information and kinematic information associated with the plurality of regions of interest. Employing the method of imaging described hereinabove registered images that are closer to reality may be obtained.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for imaging, the method comprising:
receiving a first image data set and at least one other image data set;
adaptively selecting corresponding regions of interest in each of the first image data set and the at least one other image data set based upon apriori information associated with each of the first image data set and the at least one other image data set;
selecting a customized registration method based upon the selected regions of interest and the apriori information corresponding to the selected regions of interest; and
registering each of the corresponding selected regions of interest from the first image data set and the at least one other image data set employing the selected registration method.

2. The method of claim 1, wherein the first image data set is a reference image data set and the other image data set is a floating image data set.

3. The method of claim 1, wherein the first image data set is acquired via a first imaging modality and the at least one other image data set is acquired via a second imaging modality, where the second imaging modality is different from the first imaging modality.

4. The method of claim 1, wherein the first image data set and the at least one other image data set are acquired via the same imaging modality at different points in time.

5. The method of claim 1, wherein each of the first image data set and the at least one other image data set is acquired via an imaging system, wherein the imaging system comprises one of a computed tomography imaging system, a positron emission tomography imaging system, a magnetic resonance imaging system, an X-ray imaging system, an ultrasound imaging system, or combinations thereof.

6. The method of claim 1, wherein the apriori information comprises information derived from each of first image data set and the at least one other image data set.

7. The method of claim 6, wherein the information derived from each of the first image data set and the at least one other image data set comprises geometrical information associated with each of first image data set and the at least one other image data set.

8. The method of claim 6, wherein the information derived from each of the first image data set and the at least one other image data set comprises kinematic information associated with regions of interest within each of first image data set and the at least one other image data set.

9. The method of claim 6, wherein the step of selecting corresponding regions of interest comprises segmenting each of the first image data set and the at least one other image data set into a plurality of regions of interest based upon the apriori information.

10. The method of claim 9, wherein segmenting each of the first image data set and the at least one other image data set comprises segmenting each of the first image data set and the at least one other image data set into a plurality of regions of interest based upon information from a corresponding digital imaging and communications in medicine (DICOM) header.

11. The method of claim 1, wherein the step of adaptively selecting a customized registration method further comprises obtaining information associated with each of the corresponding selected regions of interest from each of the first image data set and the at least one other image data set.

12. The method of claim 11, further comprising:
selecting a similarity metric associated with each of the corresponding selected regions of interest; and
optimizing a measure associated with the similarity metric.

13. The method of claim 11, wherein optimizing the measure associated with the similarity metric comprises selecting a transform configured to register the corresponding selected regions of interest to generate registered sub-images.

14. The method of claim 13, wherein the transform comprises a rigid transform, an affine transform, a non-rigid transform, or a combination thereof.

15. The method of claim 13, further comprising combining the registered sub-images to generate a combined registered image.

16. The method of claim 15, further comprising processing the combined registered image for display.

17. A method for imaging, the method comprising:
receiving a first image data set and at least one other image data set;
adaptively selecting corresponding regions of interest in each of the first image data set and the at least one other image data set based upon apriori information associated with each of the first image data set and the at least one other image data set;
selecting a customized registration method based upon the selected regions of interest and the apriori information corresponding to the selected regions of interest;
registering each of the corresponding selected regions of interest from the first image data set and the at least one other image data set employing the selected registration method to generate registered sub-images associated with the selected regions of interest; and
combining the registered sub-images to generate a combined registered image.

18. The method of claim 17, further comprising processing the combined registered image for display.

19. A computer readable medium comprising one or more tangible media, wherein the one or more tangible media comprise:
code adapted to receive a first image data set and at least one other image data set;
code adapted to adaptively select corresponding regions of interest in each of the first image data set and the at least one other image data set based upon apriori information associated with each of the first image data set and the at least one other image data set;
code adapted to select a customized registration method based upon the selected regions of interest and the apriori information corresponding to the selected regions of interest; and
code adapted to register each of the corresponding selected regions of interest from the first image data set and the at least one other image data set employing the selected registration method.

20. The computer readable medium, as recited in claim 19, wherein the code adapted to acquire the first image data set comprises code adapted to acquire the first image data set via a first imaging modality and the code adapted to acquire the at least one other image data set comprises code adapted to acquire the at least one other image data set via a second imaging modality, where the second imaging modality is different from the first imaging modality.

21. The computer readable medium, as recited in claim 19, wherein the code adapted to adaptively select corresponding regions of interest comprises code adapted to segment each of the first image data set and the at least one other image data set into a plurality of regions of interest based upon the apriori information.

22. The computer readable medium, as recited in claim 21, wherein the code adapted to segment each of the first image data set and the at least one other image data set comprises code adapted to segment each of the first image data set and the at least one other image data set into a plurality of regions of interest based upon information from a corresponding digital imaging and communications in medicine (DICOM) header.

23. The computer readable medium, as recited in claim 19, wherein the code adapted to select a customized registration method comprises code adapted to obtain information associated with each of the corresponding selected regions of interest from each of the first image data set and the at least one other image data set.

24. The computer readable medium, as recited in claim 23, further comprising:
code adapted to select a similarity metric associated with each of the corresponding selected regions of interest; and
code adapted to optimize a measure associated with the similarity metric.

25. The computer readable medium, as recited in claim 24, wherein code adapted to optimize the measure associated with the similarity metric comprises code adapted to select a transform configured to register the corresponding selected regions of interest to generate registered sub-images.

26. The computer readable medium, as recited in claim 25, further comprising code adapted to combine the registered sub-images to generate a combined registered image.

27. The computer readable medium, as recited in claim 26, further comprising code adapted to process the combined registered image for display.

28. A system, comprising:
at least one imaging system configured to obtain a first image data set and at least one other image data set; and
a processing sub-system operationally coupled to the at least one imaging system and configured to process each of the first image data set and the at least one other image data set to generate a registered image based upon selected regions of interest and apriori information corresponding to the selected regions of interest.

29. The system of claim 28, wherein the apriori information comprises information derived from each of the first image data set and the at least one other image data.

30. The system of claim 28, wherein the information derived from each of the first image data set and the at least one other image data set comprises kinematic information associated with regions of interest within each of first image data set and the at least one other image data set.

31. The system of claim 28, wherein the first image data set is acquired via a first imaging modality and the at least one other image data set is acquired via a second imaging modality, where the second imaging modality is different from the first imaging modality.

32. The system of claim 28, wherein the first image data set and the at least one other image data set are acquired via the same imaging modality at different points in time.

33. The system of claim 28, wherein the processing sub-system is configured to:
receive a first image data set and at least one other image data set, wherein the first image data set and the at least one other image data set are obtained via same imaging modalities or different imaging modalities;
adaptively select corresponding regions of interest in each of the first image data set and the at least one other image data set based upon apriori information associated with each of the first image data set and the at least one other image data set;
select a customized registration method based upon the selected regions of interest and the apriori information corresponding to the selected regions of interest;
register each of the corresponding selected regions of interest from the first image data set and the at least one other image data set employing the selected registration method to generate registered sub-images; and
combine the registered sub-images to generate a combined registered image.

34. The system of claim 33, further comprises a display module configured to display the transformed image.
